(19) United States
(12) Patent Application Publication
(10) Pub. No.: US 2018/0167422 A1
(43) Pub. Date: Jun. 14, 2018

(54) LOAD DISTRIBUTION APPARATUS AND LOAD DISTRIBUTION METHOD

(71) Applicant: FUJITSU LIMITED, Kawasaki-shi (JP)

(72) Inventors: Kenichi Horio, Yokohama (JP); Masahiko MURAKAMI, Kawasaki (JP)

(73) Assignee: FUJITSU LIMITED, Kawasaki-shi (JP)

(21) Appl. No.: 15/806,492

(22) Filed: Nov. 8, 2017

(30) Foreign Application Priority Data
Dec. 13, 2016 (JP) 2016-241641

(51) Int. Cl. H04L 29/06; H04L 29/08; H04L 12/18; H04L 12/24

(52) U.S. Cl. CPC H04L 65/1089; H04L 67/1008; H04L 12/1831; H04L 41/142; H04L 12/1827

(57) ABSTRACT

There is provided a load distribution apparatus configured to control a plurality of transmission devices to distribute loads of signals to be transmitted by the plurality of transmission devices, the load distribution device including a memory, and a processor coupled to the memory and the processor configured to receive a transmission request for transmitting an image signal without including a voice or a voice-attached image signal captured at a predetermined place, calculate a probability of changing a transmission mode in a transmission device of the plurality of transmission devices from transmission of the image signal to transmission of the voice-attached image signal, based on a history of transmissions of the image signal and the voice-attached image signal at the predetermined place, and assign the transmission request to the transmission device having the lowest probability among the plurality of transmission devices.

### CROSS-REFERENCE TO RELATED APPLICATION

This application is based upon and claims the benefit of priority of the prior Japanese Patent Application No. 2016-241641, filed on Dec. 13, 2016, the entire contents of which are incorporated herein by reference.

### FIELD

The embodiments discussed herein are related to a load distribution apparatus and a load distribution method.

### BACKGROUND

It is known that a conference system for realizing one-way or two-way communication among a plurality of points by transmitting image signals or voice-attached image signals via a network is provided.

This conference system is used for remote support, which supports workers at a site where various kinds of work, for example, inspection work is carried out from a remote location, as an aspect. For example, using remote support, it is possible to build a support system in which a person having highly specialized skills is placed at an office at a remote location as a supporter, and the supporter monitors a plurality of sites. Thereby, the number of workers at a site is reduced, or high-quality support is provided to a plurality of sites.

Here, in a remote support system, in order to use the resources of a supporter effectively, as an example, the following two transmission modes are changed in accordance with scenes. One of the transmission modes is image signal transmission in which an image signal is transmitted from a site to a remote location. The other of the transmission modes is voice-attached image signal transmission in which an image signal is transmitted from a site to a remote location and voice is transmitted between a worker and a supporter in two-way communication. For example, a list of image signals that are transmitted from a plurality of sites that are in the supporter's charge is displayed to the supporter. Next, voice-attached image signal transmission is started between the supporter and a site selected by the supporter from the list. Thereby, the supporter narrows down scenes for supporting sites to important situation via voice-attached image signal transmission.

In such a remote support system, as the number of sites or the number of supporters who support sites increase, the transmission load increases. Accordingly, a load distribution apparatus, namely a so-called load balancer is used. For example, a load balancer assigns a request of image signal transmission to a transmission device having the smallest load out of a plurality of transmission devices that transmit an image signal or a voice-attached image signal so as to realize load distribution.

Related-art techniques are disclosed in Japanese Laid-open Patent Publication Nos. 2013-150134 and 2011-008822.

### SUMMARY

According to an aspect of the invention, a load distribution apparatus is configured to control a plurality of transmission devices to distribute loads of signals to be transmitted by the plurality of transmission devices, the load distribution device includes a memory, and a processor coupled to the memory and the processor configured to receive a transmission request for transmitting an image signal without including a voice or a voice-attached image signal captured at a predetermined place, calculate a probability of changing a transmission mode in a transmission device of the plurality of transmission devices from transmission of the image signal to transmission of the voice-attached image signal, based on a history of transmissions of the image signal and the voice-attached image signal at the predetermined place, and assign the transmission request to the transmission device having the lowest probability among the plurality of transmission devices.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the functional configuration of a system according to a first embodiment;

FIG. 2 is a diagram illustrating an example of a screen transition;

FIG. 3 is a block diagram illustrating the functional configuration of a load distribution apparatus according to the first embodiment;

FIG. 4 is a diagram illustrating an example of history information;

FIG. 5 is a diagram illustrating an example of numerical calculations of load prediction values;

FIG. 6 is a flowchart illustrating a procedure of the entire processing according to the first embodiment;

FIG. 7 is a flowchart illustrating degree-of-risk calculation processing according to the first embodiment;

FIG. 8 is a diagram illustrating an application of history information;

FIG. 9 is a diagram illustrating an example of setting information of a weighting factor β; and

FIG. 10 is a diagram illustrating an example of the hardware configuration of a computer that executes load distribution programs according to the first embodiment and a second embodiment.

### DESCRIPTION OF EMBODIMENTS

However, out of a plurality of transmission devices that transmit an image signal or a voice-attached image signal, it is sometimes not possible for a load balancer that assigns a request of an image signal transmission to a transmission device having the smallest load to reduce deterioration in the quality of remote support.

That is to say, in the above-described load balancer, a transmission request of an image signal is only assigned to a transmission device having the smallest load. Accordingly, even if image signal transmission is equally assigned to a plurality of transmission devices, transmission requests of a voice-attached image signal are sometimes unevenly imposed on a specific transmission device after image signal transmission is started. In this case, the transmission load of a transmission device having excessive requests of voice-attached image signal transmission increases. As a result, a packet loss or a transmission delay occurs at the transmission device, and the quality of remote support deteriorates.

In the following, a description will be given of a load distribution apparatus and a load distribution method that are capable of reducing deterioration in the quality of remote support with reference to the accompanying drawings. In this regard, the embodiments will not limit the disclosed technique. It is possible to suitably combine each of the embodiments within a range in which inconsistencies of the processing contents do not arise.

### First Embodiment

System configuration

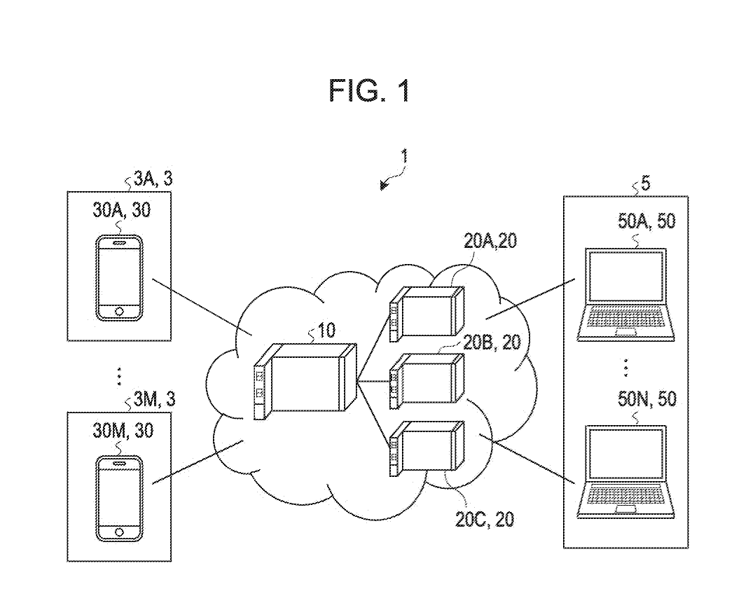

FIG. 1 is a diagram illustrating an example of the functional configuration of a system according to a first embodiment. A remote support system 1 illustrated in FIG. 1 transmits an image signal or a voice-attached image signal via a network so as to provide remote support services between a site 3 and a remote location 5 in one-way or two-way communication. In this regard, in the following, the case where an image signal is transmitted as a signal of a stream of a motion picture is exemplified. However, it does not matter if an image signal is transmitted as a signal of a stream of still images.

As part of the remote support services, the remote support system 1 transmits an image signal from the site 3 to the remote location 5 and realizes load distribution for reducing the situation in which requests of a voice-attached image signal conference that transmits voice between the site 3 and the remote location 5 are unevenly made to a part of a plurality of remote support servers 20A to 20C.

As illustrated in FIG. 1, the remote support system 1 includes a load distribution apparatus 10, remote support servers 20A to 20C, worker terminals 30A to 30M, and supporter terminals 50A to 50N. In the following, when a generic name is given to the remote support servers 20A to 20C, it is sometimes described as a “remote support server 20”, when a generic name is given to the worker terminals 30A to 30M, it is sometimes described as a “worker terminal 30”, and when a generic name is given to the supporter terminals 50A to 50N, it is sometimes described as a “supporter terminal 50”.

The load distribution apparatus 10 is an apparatus that performs load distribution, namely a so-called load balancer.

It is possible to implement the load distribution apparatus 10 by installing a load distribution program that realizes the above-described load distribution on a desired computer as package software or online software as an embodiment. For example, the load distribution apparatus 10 may be implemented as a Web server that provides the above-described load distribution, or as a cloud service that provides the above-described load distribution by outsourcing.

The remote support server 20 is a computer that provides the above-described remote support services.

It is possible to implement the remote support server 20 by installing a remote support program that provides the above-described remote support services on a desired computer as package software or online software as an embodiment. For example, the remote support server 20 may be implemented as a Web server that provides the above-described remote support services, or as a cloud service that provides the above-described remote support services by outsourcing. In this regard, in FIG. 1, the three servers, namely the remote support servers 20A to 20C are illustrated. However, the number of remote support servers 20 may be two, or four or more.

The worker terminal 30 is a terminal device used by a worker who carries out work at the site 3. Here, as an example of “work”, inspection work of measuring instruments, such as a meter, a valve, or the like is given.

As an embodiment, for the worker terminal 30, it is possible to use a mobile communication terminal, such as a smartphone, a cell phone, a Personal Handyphone System (PHS), or the like, and further a mobile terminal device, such as a slate terminal, a tablet terminal, or the like. In addition, it is possible to use a wearable terminal, such as smart glasses, a head mounted display, or the like for the worker terminal 30. A camera that captures an image to be transmitted to the supporter terminal 50, and a microphone that receives input of voice to be transmitted to the supporter terminal 50, and the like are mounted on the worker terminal 30. It is possible to use such sensor devices that are mounted on a mobile terminal device and a wearable terminal without change. In this regard, in FIG. 1, one worker terminal 30 is illustrated for each one site 3. A plurality of worker terminals 30 may be included in one site 3. Also, here, the case where the worker terminal 30 is a mobile information processing terminal is exemplified. However, the worker terminal 30 may be a stationary information processing terminal that is disposed at the site 3.

The supporter terminal 50 is a terminal device used by a supporter, who supports a worker, who is located at the site 3, at the remote location 5, such as an office, or the like. Here, “remote location” is described as a relative expression compared with the site 3 as only an aspect. However, the supporter may be located at a remote location, and does not limit to be located at a remote location.

As an embodiment, it is possible to use a personal computer for the supporter terminal 50. The implementation of the supporter terminal 50 is not limited to a stationary information processing apparatus, such as the personal computer, or the like. It is possible to use various mobile terminal devices as the supporter terminal 50.

Here, in the remote support system 1, in order to effectively utilize the resources of a supporter, two transmission modes are changed as an example. For example, one of the transmission modes is image signal transmission in which an image signal is transmitted from the site 3 to the remote location 5, and the other of the transmission modes is a voice-attached image signal conference in which an image signal is transmitted from the site 3 to the remote location 5 and a voice signal is transmitted between the site 3 and the remote location 5 in two ways. In this regard, as described above, the target of transmission does not have to be an image signal. The signal of still images may be transmitted at a predetermined frequency of occurrence or rate. That is to say, image signal transmission may be replaced with transmission of a signal of still images, and a voice-attached image signal conference may be replaced with a conference in which signals of voice-attached still images are transmitted.

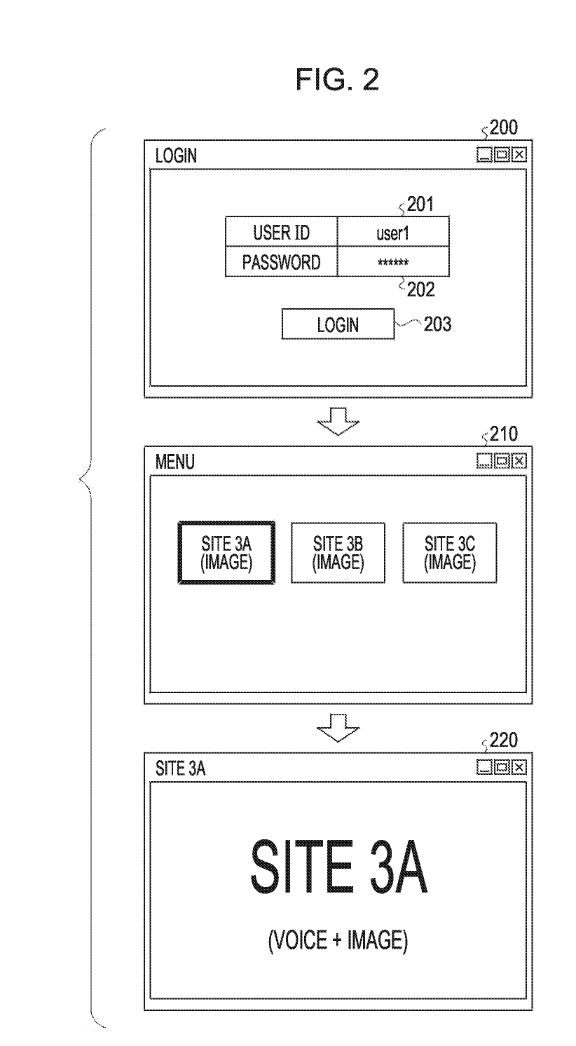

The two transmission modes represents only an example, and are requested from the supporter terminal 50 to the load distribution apparatus 10 via a graphical user interface (GUI) screen transition illustrated in FIG. 2.

FIG. 2 is a diagram illustrating an example of a screen transition. In FIG. 2, a description will be given of the case where the supporter 5A who uses the supporter terminal 50A supports three sites 3A to 3C, for example. As illustrated in FIG. 2, a login screen 200 is displayed on the supporter terminal 50. The login screen 200 includes GUI components, such as a text box 201, a text box 202, and a button 203, and the like. Among these, a user identification (ID) is input to the text box 201 out of the accounts assigned to the supporters, and a password is input to the text box 202. When the login button 203 is pushed in a state in which a user ID and a password have been input, login authentication is carried out. Along with the success of the login authentication, the supporter terminal 50 requests an image signal transmission to the load distribution apparatus 10. The load distribution apparatus 10 then assigns a request of image signal transmission to any remote support server 20 of the three remote support servers 20A to 20C.

In this manner, the remote support server 20, to which the request of image signal transmission has been assigned, starts transmission, to the supporter terminal 50, of image signals from the worker terminals 30A to 30C of the sites 3A to 3C that are associated with the account of the supporter 5A as the site 3 that is taken charge by the supporter 5A. The display of the supporter terminal 50 then changes from the login screen 200 to a menu screen 210. Image signals of the sites 3A to 3C, which are transmitted from the worker terminals 30A to 30C at the individual sites 3A to 3C, respectively, are listed on the menu screen 210 by thumbnail display. An image signal is selected from a list of the image signals that are thumbnail displayed in this manner. For example, when a thumbnail image signal of the site 3A is selected, a request of a voice-attached image signal conference of the site 3A is made from the supporter terminal 50 to the load distribution apparatus 10 along with the selection.

The load distribution apparatus 10 then transfers the request of the voice-attached image signal conference of the site 3A to the remote support server 20 to which a request of an image signal transmission of the site 3A has been assigned. As a result, the transmission mode is changed from the image signal transmission to the voice-attached image signal conference. Thereby the remote support server 20 continues transmission of the image signal from the worker terminal 30A at the site 3A to the supporter terminal 50 and starts the transmission of voice between the worker terminal 30A corresponding to the site 3A and the supporter terminal 50A in two ways. The display of the supporter terminal 50A then changes from the menu screen 210 to a site 3A screen 220. For example, the remote support server 20 displays the image signal that is transmitted from the worker terminal 30A by enlarging the size of the image signal larger than that of the image signal displayed by thumbnail on the menu screen 210 to the site 3A screen 220. Further, the remote support server 20 outputs voice transmitted from the worker terminal 30A from a voice output unit included in the supporter terminal 50A, for example, a speaker or an earphone. In this regard, the remote support server 20 also outputs the voice transmitted from the supporter terminal 50A to the voice output unit included in the worker terminal 30A.

In this manner, the image signal displayed on the supporter terminal 50 ought to be transmitted from the worker terminal 30A carried by at least one worker out of the workers who are working at the site 3A. On the other hand, voice transmitted between the two points, the site 3A and the remote location 5, does not have to be limited to have two channels, namely the worker terminal 30A and the supporter terminal 50A.

That is to say, if the number of workers at the site 3A is one, it is sufficient to connect the worker terminal 30A and the supporter terminal 50A on a one-to-one basis. However, in the case where there are a plurality of workers (m persons) at the site 3A, information sharing sometimes becomes incomplete by one-to-one connection. Because all the workers who work at the same site 3A do not have to be staying nearby the worker terminal 30A that performs transmission to the supporter terminal 50A by one-to-one connection, and thus there is a possibility that a failure in hearing or a failure in saying might occur.

Accordingly, between the two points, namely the site 3A and the remote location 5, voice is transmitted between the plurality of worker terminals 30A-1 to 30A-m and the supporter terminal 50A in two ways such that m participants at the site 3A and the supporter at the remote location 5 are capable of sharing conversation. In this manner, if the number of participants in a voice conference at the site 3A is plural, mixing of the voice signals of the individual channels transmitted from the plurality of worker terminals 30A-1 to 30A-m and the supporter terminal 50A to the remote support server 20 is carried out.

The “mixing” mentioned here refers to mixing processing of the voice signals transmitted from the plurality of worker terminals 30A-1 to 30A-m and the supporter terminal 50A. In the mixing, for each terminal of the plurality of worker terminals 30A-1 to 30A-m and the supporter terminal 50A, mixing voice signals is performed by excluding a voice signal transmitted from a terminal used as an output destination of the voice signal after the mixing out of the voice signals transmitted from the individual terminals, and the mixed voice signal is transmitted to each terminal. This processing is performed in order to reduce an uncomfortable feeling that arises from an earphone or, the like when a voice collected from the own microphone is output.

When such mixing processing is performed, the remote support server 20 continues to perform mixing processing of the voice signals for the same number of combinations as the number of all the participants in the site 3A and the remote location 5, namely (m+1) persons, that is to say, (m+1) combinations. Therefore the load imposed on the remote support server 20 when a voice-attached image signal conference is carried out is higher than when an image signal transmission is carried out. The larger of the number of participants, the larger becomes the difference. In this regard, a description has been given here of the case where the number of participants to the remote location 5 is one person, namely, the supporter 5A. A plurality of participants may be joined to the remote location 5 as a matter of course.

Configuration of Load Distribution Apparatus

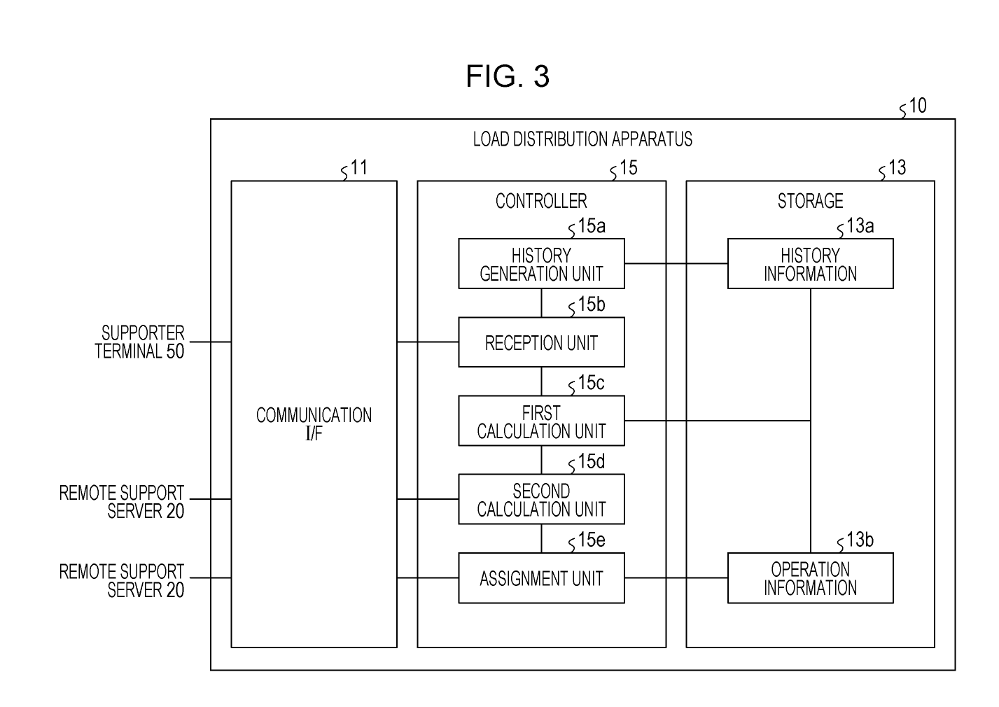

Next, a description will be given of the functional configuration of a load distribution apparatus according to the present embodiment. FIG. 3 is a block diagram illustrating the functional configuration of a load distribution apparatus 10 according to the first embodiment. As illustrated in FIG. 3, the load distribution apparatus 10 includes a communication interface unit (communication I/F) 11, a storage 13, and a controller 15. In this regard, the load distribution apparatus 10 may include various functional units possessed by a well-known computer, for example, an input unit, an output unit, and the like in addition to the functional units illustrated in FIG. 3.

The communication I/F 11 is an interface that performs communication with the other devices, for example, the remote support server 20, the worker terminal 30, and the supporter terminal 50.

As an embodiment, it is possible to employ a network interface card, such as a local area network (LAN) card, or the like for the communication I/F 11. For example, the communication I/F 11 receives a request of an image signal transmission or a voice-attached image signal conference from the supporter terminal 50. Also, the communication I/F 11 transfers a request of an image signal transmission or a voice-attached image signal conference received from the supporter terminal 50 to an assigned remote support server 20.

The storage 13 is a storage device that stores data used by various programs, such as the application program that realizes the above-described load distribution functions, and the like including the operating system (OS) executed by the controller 15.

As an embodiment, it is possible to implement the storage 13 as an auxiliary storage in the server device 10. For example, it is possible to employ a hard disk drive (HDD), an optical disc, a solid state drive (SSD), or the like, as a memory, for the storage 13. In this regard, the storage 13 does not have to be implemented as an auxiliary storage, and it is possible to implement the storage 13 as a main storage device in the server device 10. In this case, it is possible to employ various semiconductor memory elements, for example, a random access memory (RAM) or a flash memory for the storage 13.

The storage 13 stores history information 13a and operation information 13b as an example of data used by the program executed on the controller 15. In addition to these data, it is possible to store electronic data as follows. For example, it is possible to store information, such as identification information for identifying the worker terminal 30 and the supporter terminal 50, and the like in addition to the account information of the workers and supporters. In this regard, a description will be given later of the history information 13a with a description of the controller 15 that generates the history information 13a.

The operation information 13b is information regarding the operation of the remote support services.

As an embodiment, for the operation information 13b, it is possible to employ the data associated with the identification information of the site 3 where the remote support services are in operation at the remote support server 20 for each identification information of the remote support server 20. For example, after a successful login, a record including the identification information of the remote support server 20 to which a request of an image signal transmission has been assigned, for example, a server identification (ID), and the identification information of the site 3 associated with the account of the supporter as the site 3 handled by the supporter, for example, a site ID, is recorded as a new entry of the operation information 13b. After that, if the image signal transmission is terminated, a record corresponding to the site 3 included in the menu screen 210 is deleted out of the records included in the operation information 13b. Also, if the transmission mode of a part of the sites is changed from an image signal transmission to a voice-attached image signal conference, the records of the site ID having the transmission mode changed to a voice-attached image signal conference are left without change, whereas the records having the other site IDs are deleted from the operation information 13b. In this regard, if a voice-attached image signal conference is terminated, the record having the site ID is also deleted from the operation information 13b.

The controller 15 performs the total control of the load distribution apparatus 10.

As an embodiment, it is possible to implement the controller 15 by a hardware processor, such as a central processing unit (CPU), a micro processing unit (MPU), or the like. Here, a CPU or a MPU has been described as an example of a processor. However, it is possible to implement the controller 15 by any processor regardless of whether a general-purpose type or a specialized type. In addition, the controller 15 may be realized by hard-wired logic, such as an application specific integrated circuit (ASIC), a field programmable gate array (FPGA), or the like.

The controller 15 loads a load distribution program that performs the functions of the above-described load distribution on a work area of a RAM, such as a dynamic random access memory (DRAM), a static random access memory (SRAM), or the like, which is implemented as an unillustrated main storage device so as to virtually realize the following processing.

As illustrated in FIG. 3, the controller 15 includes a reception unit 15b, a history generation unit 15a, a first calculation unit 15c, a second calculation unit 15d, and an assignment unit 15e.

The reception unit 15b receives a request of an image signal transmission, a voice-attached image signal conference, or the like.

As an embodiment, the reception unit 15b receives a request of an image signal transmission, a voice-attached image signal conference, or the like from the supporter terminal 50 only as an example. For example, it is possible for the reception unit 15b to receive a login operation in the login screen 200 displayed on the supporter terminal 50 as a request of an image signal transmission. Also, it is possible for the reception unit 15b to receive the operation of selecting the site 3 from the list of image signals of the site 3, which is thumbnail displayed as the menu screen 210 on the supporter terminal 50 as a request of a voice-attached image signal conference.

The history generation unit 15a generates history of image signal transmission and voice-attached image signal conferences.

As an embodiment, if the reception unit 15b receives a request of image signal transmission, the history generation unit 15a generates a new record in the history information 13a stored in the storage 13. The history generation unit 15a then stores the identification information of the site 3 from which a request of image signal transmission has been received, for example, the site ID and the start time of the image signal transmission in association with each other in the new record. After that, if the reception unit 15b receives a request of a voice-attached image signal conference, the history generation unit 15a searches a record corresponding to the identification information of the site 3 from which a request of a voice-attached image signal conference has been received out of the records of the history information 13a stored in the storage 13. The history generation unit 15a then records the number of workers who participate in the voice conference at the site 3 in the records searched before. Further, the history generation unit 15a sets the information corresponding to “presence” in the binary information indicating presence or absence of a voice-attached image signal conference.

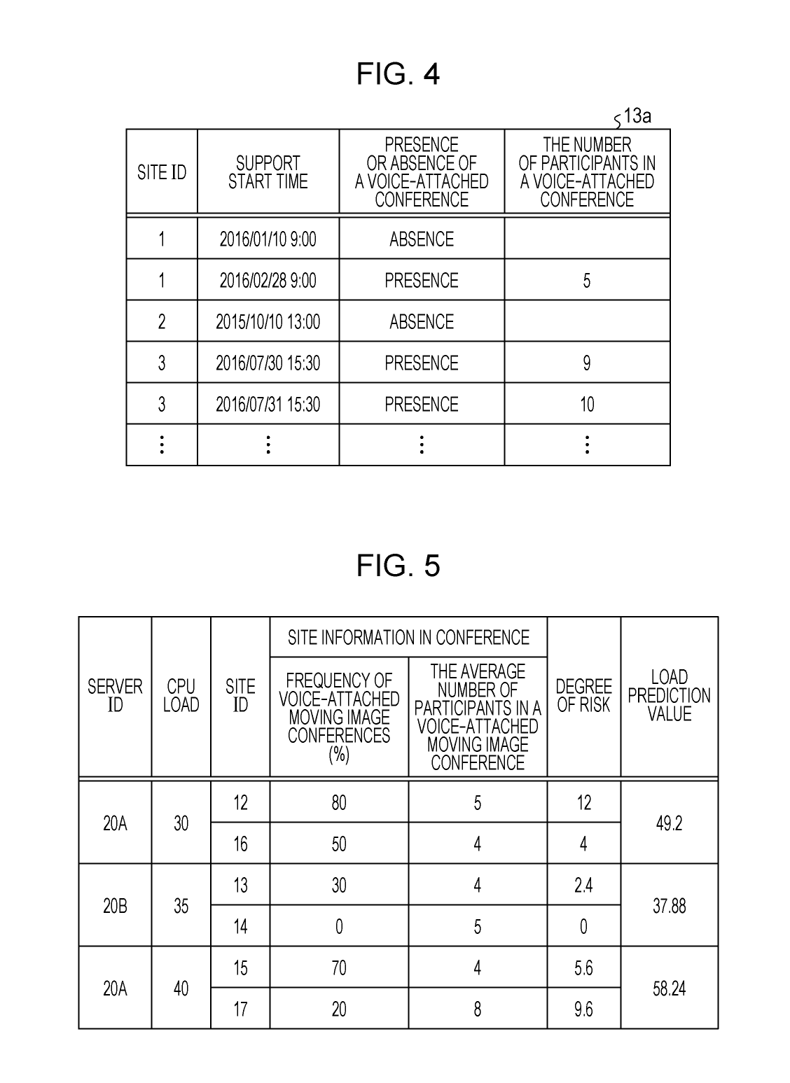

FIG. 4 is a diagram illustrating an example of the history information 13a. In FIG. 4, five cases in history are exemplified. However, this is only an example, and it is possible to record a history having the contents in accordance with the implementation as a matter of course. For example, the first record from the top in FIG. 4 indicates that a site identified by the site ID “1” has started image signal transmission at 9 o'clock on Jan. 10, 2016. Also, the second record from the top in FIG. 4 indicates that a site identified by the site ID “1” has started image signal transmission at 9 o'clock on Feb. 28, 2016. Moreover for the third to the fifth records, although the site ID that identifies a site and the start date and time differ, it is possible for the computer to recognize a site and a start date and time of image signal transmission in the same manner as the first and the second records from the top.

Out of these five cases in history, the first and the third records from the top indicate that the transmission mode has not been changed from image signal transmission to a voice-attached image signal conference. On the other hand, the second, the fourth, and the fifth records from the top indicate that the transmission mode has been changed from image signal transmission to a voice-attached image signal conference during the image signal transmission. For example, the second record from the top indicates that the number of participants in the voice-attached image signal conference is five. Also, the fourth record from the top indicates that the number of participants in the voice-attached image signal conference is nine. Further, the fifth record from the top indicates that the number of participants in the voice-attached image signal conference is 10.

The first calculation unit 15c calculates the degree of risk (probability) of a voice-attached image signal conference taking place. Here, the case of calculating the degree of risk of the transmission mode being changed from image signal transmission to a voice-attached image signal conference is exemplified.

As an embodiment, the first calculation unit 15c starts the processing when the reception unit 15b receives a request of image signal transmission as an example. That is to say, the first calculation unit 15c reads the operation information 13b stored in the storage 13. Next, the first calculation unit 15c selects one of the site IDs included in the operation information 13b. The first calculation unit 15c then determines whether or not the transmission mode of the site ID selected before has been changed to a voice-attached image signal conference. At this time, if the transmission mode has been changed to a voice-attached image signal conference, it turns out that there is no risk of being further changed. Accordingly, the first calculation unit 15c sets the return value of the degree of risk of the site ID to “0”.

On the other hand, if the transmission mode has been changed to a voice-attached image signal conference, the first calculation unit 15c searches the records of the history information 13a stored in the storage 13 for a record corresponding to the site ID selected before. At this time, if there are no hits as a result of the search, it turns out that neither image signal transmission nor a voice-attached image signal conference took place at the site identified by the site ID in the past. In this case, it is difficult for the first calculation unit 15c to predict the degree of risk, and thus the first calculation unit 15c set the return value of the degree of risk of the site ID to “0”.

Also, if the search gets a hit, the first calculation unit 15c calculates a frequency of occurrence Ra of having held a voice-attached image signal conference at the site having the site ID selected before. For example, when calculation is performed by setting the number of records in which the search got a hit to the denominator, and setting the number of records in which the binary information of presence or absence of a voice-attached conference is presence to the numerator, it is possible to calculate the frequency of occurrence Ra. At this time, if the frequency of occurrence Ra is 0, it turns out that there has not been a change to a voice-attached image signal conference in the past at the site having the site ID. In this case, the first calculation unit 15c sets the return value of the degree of risk of the site ID to “0”.

Also, if the frequency of occurrence Ra is not 0, the first calculation unit 15c performs predetermined statistical processing, for example, average processing on the number of participants in voice-attached image signal conferences among the records in which the presence or absence of a voice-attached image signal conference is set to presence so as to calculate the average number of participants n. The first calculation unit 15c then calculates the degree of risk from the frequency of occurrence Ra of holding a voice-attached image signal conference and the average number of participants n. For example, it is possible for the first calculation unit 15c to calculate the degree of risk by the following expression (1).

The degree of risk=Ra*n*(n−2) . . . expression (1)

After that, the first calculation unit 15c repeatedly calculate the above-described degree of risk until there are no unselected site IDs in the site IDs included in the operation information 13b. In this regard, here, an example in which the degree of risk is calculated using the expression (1) is described only as an example. The average number of participants n does not have to be used for calculating the degree of risk, and only the frequency of occurrence Ra may be used for calculating the degree of risk.

The second calculation unit 15d calculates the load prediction value of each remote support server 20.

As an embodiment, the second calculation unit 15d inquires the CPU load of each remote support server 20 in operation so as to obtain the CPU load of each remote support server 20. The second calculation unit 15d then calculates the load prediction value for each remote support server 20 based on the CPU load for each remote support server 20, and the degree of risk calculated by the first calculation unit 15c. For example, it is possible for the second calculation unit 15d to calculate the load prediction value in accordance with the following expression (2). In this regard, “α” and “β” in the following expression (2) are weighting factors.

The load prediction value=α*the current CPU load+β*(the sum of the degree of risk of the individual sites) . . . expression (2)

The assignment unit 15e assigns the request of image signal transmission to the remote support server 20.

As an embodiment, when the second calculation unit 15d has calculated a load prediction value for each remote support server 20, the assignment unit 15e selects a remote support server Sa having the minimum load prediction value. The assignment unit 15e then transfers the request of image signal transmission from the supporter terminal 50 to the remote support server Sa selected before out of the remote support servers 20 in operation so as to assign the request of image signal transmission to the remote support server Sa.

Example of numerical calculation

FIG. 5 is a diagram illustrating an example of numerical calculations of load prediction values. FIG. 5 illustrates an example in which three remote support servers 20A, 20B and 20C are in operation, and the CPU loads measured by each of the remote support servers 20 are 30%, 35%, and 40% in the order of the remote support servers 20A, 20B, and 20C, respectively. In this regard, here, the load prediction value is calculated when a in the expression (2), which is a calculation expression of a load prediction value, is set to “1”, and β is set to “1.2”.

Further, in the example in FIG. 5, it turned out that as a result of the reference to the operation information 13b, the remote support server 20A performs image signal transmission with the two sites identified by the site IDs “12” and “16”, the remote support server 20B performs image signal transmission with the two sites identified by the site IDs “13” and “14”, and the remote support server 20C performs image signal transmission with the two sites identified by the site IDs “15” and “17”.

Further, in the example in FIG. 5, it turned out that as a result of the reference to the operation information 13a, the frequency of occurrence Ra of carrying out voice-attached image signal conferences at the site identified by the site ID “12” is calculated as “80%” and the average number of participants n is calculated as “five”. Further, in the example in FIG. 5, it turned out that as a result of the reference to the operation information 13a, the frequency of occurrence Ra of carrying out voice-attached image signal conferences at the site identified by the site ID “16” is calculated as “50%” and the average number of participants n is calculated as “four”.

Also, in the example in FIG. 5, it turned out that as a result of the reference to the operation information 13a, the frequency of occurrence Ra of carrying out voice-attached image signal conferences at the site identified by the site ID “13” is calculated as “30%” and the average number of participants n is calculated as “four”. Further, in the example in FIG. 5, it turned out that as a result of the reference to the operation information 13a, the frequency of occurrence Ra of carrying out voice-attached image signal conferences at the site identified by the site ID “14” is calculated as “0%” and the average number of participants n is calculated as “five”.

Also, in the example in FIG. 5, it turned out that as a result of the reference to the operation information 13a, the frequency of occurrence Ra of carrying out voice-attached image signal conference at the site identified by the site ID “15” is “70%” and the average number of participants n is calculated as “four”. Further, in the example in FIG. 5, it turned out that as a result of the reference to the operation information 13a, the frequency of occurrence Ra of carrying out voice-attached image signal conferences at the site identified by the site ID “17” is calculated as “20%” and the average number of participants n is calculated as “eight”.

Under such a calculation state of the frequency of occurrence Ra and the average number of participants n, the degree of risk is calculated as follows.

Load Prediction Value of Server 20A

For example, the degree of risk of the site identified by the site ID “12” is calculated as “12” by substituting the frequency of occurrence Ra=80% and the average number of participants n=five in the expression (1), and thus as a result of the calculation “(80/100)*5*(5−2)”. Further, the degree of risk of the site identified by the site ID “16” is calculated as “4” by substituting the frequency of occurrence Ra=50% and the average number of participants n=four in the expression (1), and thus as a result of the calculation “(50/100)*4*(4−2)”. By substituting the degrees of risk of site IDs “12” and “16”, and the CPU load of “30%” in the expression (2), the load prediction value of the remote support server 20A is calculated as “49.2” as a result of the calculation “30+1.2*(12+4)”.

Load Prediction Value of Server 20B

For example, the degree of risk of the site identified by the site ID “13” is calculated as “2.4” by substituting the frequency of occurrence Ra=30% and the average number of participants n=four in the expression (1), and thus as a result of the calculation “(30/100)*4*(4−2)”. Further, the degree of risk of the site identified by the site ID “14” is calculated as “0” by substituting the frequency of occurrence Ra=0% and the average number of participants n=five in the expression (1), and thus as a result of the calculation “(0/100)*5*(5−2)”. By substituting the degrees of risk of site IDs “13” and “14”, and the CPU load of “35%” in the expression (2), the load prediction value of the remote support server 20B is calculated as “37.8” as a result of the calculation “35+1.2*(2.4+0)”.

Load Prediction Value of Server 20C

For example, the degree of risk of the site identified by the site ID “15” is calculated as “5.6” by substituting the frequency of occurrence Ra=70% and the average number of participants n=four in the expression (1), and thus as a result of the calculation “(70/100)*4*(4−2)”. Further, the degree of risk of the site identified by the site ID “17” is calculated as “9.6” by substituting the frequency of occurrence Ra=20% and the average number of participants n=eight in the expression (1), and thus as a result of the calculation “(20/100)*8*(8−2)”. By substituting the degrees of risk of site IDs “15” and “17” and the CPU load “40%” in the expression (2), the load prediction value of the remote support server 20C is calculated as “58.24” as a result of the calculation “40+1.2*(5.6+9.6)”.

Comparison with Existing Technique

If a request of image signal transmission is assigned based on the magnitude of the CPU load as the existing techniques, the request of image signal transmission is assigned to the remote support server 20A having the minimum CPU load. On the other hand, in the present embodiment, the load prediction values are arranged in the order of the remote support server 20B, the remote support server 20A, and the remote support server 20C when listed in ascending order. As a result, in the present embodiment, the request of image signal transmission is assigned to the remote support server 20B.

In this manner, the CPU load only reveals the current load of each remote support server 20. However, by the load prediction value, it is possible to evaluate the load including a potential risk of changing the transmission mode from image signal transmission to a voice-attached image signal conference. By assigning a request of image signal transmission in accordance with the load prediction value, it becomes possible to reduce uneven assignment of a voice-attached image signal conference to a part of the plurality of remote support servers 20A to 20C.

Processing Flow

Next, a description will be given of the processing flow of the load distribution apparatus 10 according to the present embodiment. In this regard, here, after a description is given of (1) The entire processing performed by the load distribution apparatus 10, a description will be given of (2) Calculation processing of degree of risk, which is performed as a subroutine of (1).

(1) The Entire Processing

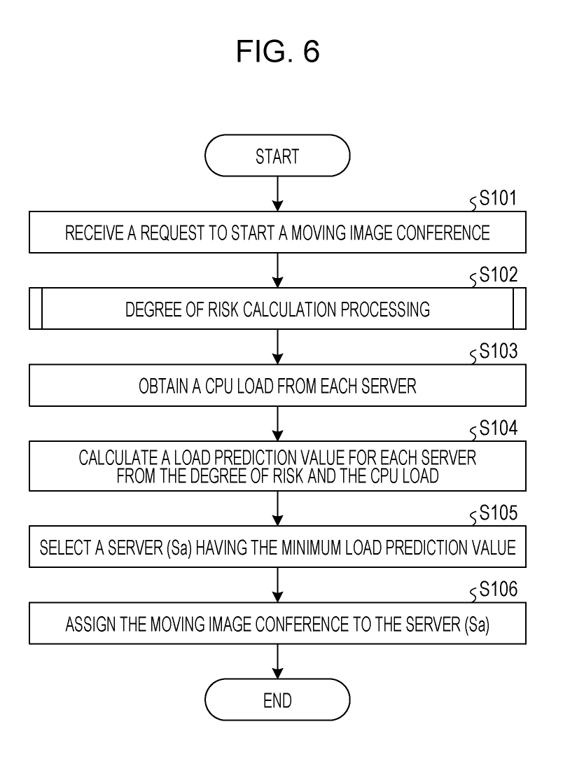

FIG. 6 is a flowchart illustrating a procedure of the entire processing according to the first embodiment. This processing is started when a request of image signal transmission is received as an example. As illustrated in FIG. 6, when a request of image signal transmission is received (operation S101), the first calculation unit 15c performs “calculation processing of degree of risk”, in which the degree of risk of changing the transmission mode from image signal transmission to a voice-attached image signal conference is calculated for each site in operation of the remote support service provided by each remote support server 20 (operation S102).

Next, the second calculation unit 15d inquires the CPU load of each remote support server 20 in operation so as to obtain the CPU load of each remote support server 20 (operation S103). The second calculation unit 15d then calculates the load prediction value for each remote support server 20 based on the CPU load of each remote support server 20 obtained in operation S103 and the degree of risk calculated in operation S102 (operation S104).

After that, the assignment unit 15e selects a remote support server Sa having the minimum load prediction value out of the load prediction values calculated in operation S104 (operation S105). The assignment unit 15e then transfers the request of image signal transmission from the supporter terminal 50 to the remote support server Sa selected before out of the remote support server 20 in operation so as to assign the request of image signal transmission to the remote support server Sa (operation S106), and terminates the processing.

(2) Calculation Processing of Degree of Risk

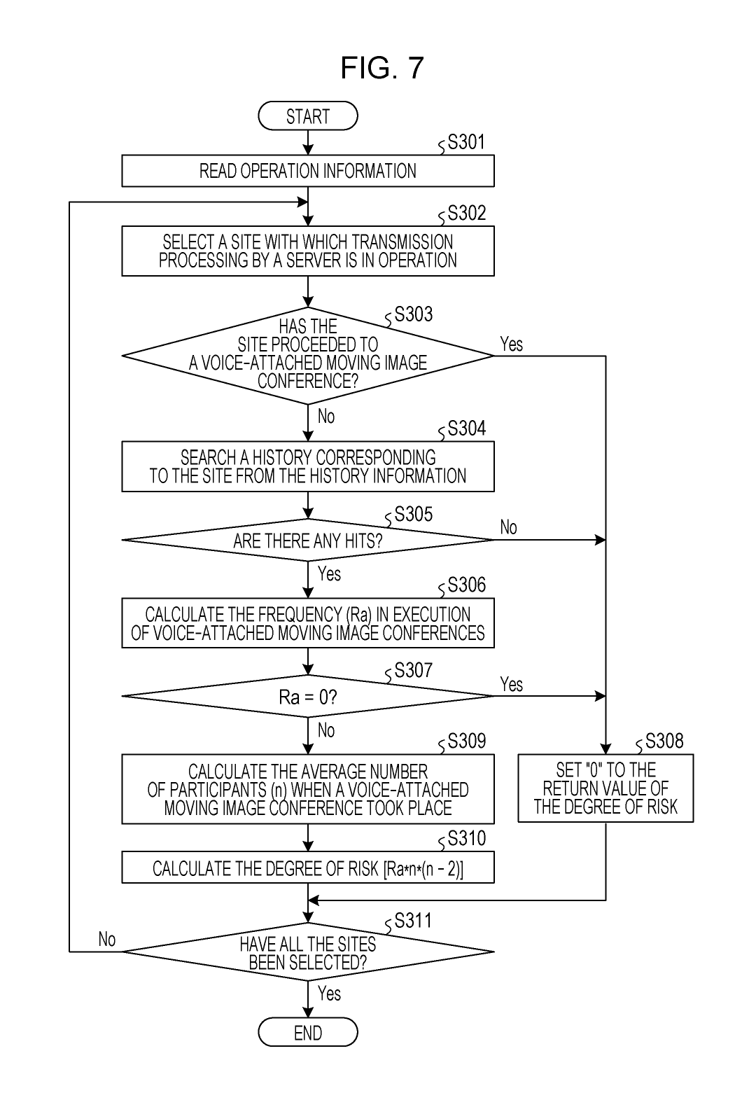

FIG. 7 is a flowchart illustrating degree-of-risk calculation processing according to the first embodiment. This processing is the processing corresponding to the operation S102 illustrated in FIG. 6 and is performed when a request of image signal transmission is received.

As illustrated in FIG. 7, the first calculation unit 15c reads the operation information 13b stored in the storage 13 (operation S301). Next, the first calculation unit 15c selects one of the site IDs included in the operation information 13b read in operation S301 (operation S302).

Next, the first calculation unit 15c determines whether or not the transmission mode of the site ID selected in operation S302 has proceeded to a voice-attached image signal conference (operation S303). At this time, if the transmission mode has proceeded to a voice-attached image signal conference (operation S303: Yes), it turns out that there is no risk of being changed further. Accordingly, the first calculation unit 15c sets the return value of the degree of risk of the site ID to “0” (operation S308), and the processing proceeds to operation S311.

On the other hand, if the transmission mode has not proceeded to a voice-attached image signal conference (operation S303: No), the first calculation unit 15c searches for a record corresponding to the site ID selected in operation S302 out of the records of the history information 13a stored in the storage 13 (operation S304).

At this time, if the search gets no hits (operation S305: No), it turns out that no image signal transmission and voice-attached image signal conferences have been held at the site identified by the site ID in the past. In this case, it is difficult to predict the degree of risk, and thus the first calculation unit 15c sets the return value of the degree of risk of the site ID to “0” (operation S308), and the processing proceeds to operation S311.

Also, if the search gets a hit (operation S305: Yes), the first calculation unit 15c calculates the frequency of occurrence Ra of carrying out voice-attached image signal conferences at the site having the site ID selected in operation S302 (operation S306). For example, it is possible to calculate the frequency of occurrence Ra by setting the number of records from which the search got a hit to the denominator, and setting the number of records in which the binary information of presence or absence of a voice-attached conference is presence to the numerator.

At this time, if the frequency of occurrence Ra is 0 (operation S307: Yes), it turns out that there have been no changes to a voice-attached image signal conference at the site having the site ID in the past. In this case, the first calculation unit 15c sets the return value of the degree of risk of the site ID to “0” (operation S308), and the processing proceeds to operation S311.

Also, if the frequency of occurrence Ra is not 0 (operation S307: No), the first calculation unit 15c performs predetermined statistical processing, for example, the average processing on the number of participants in voice-attached image signal conferences in the records having presence in the indicator of presence or absence of a voice-attached image signal conference so as to calculate the average number of participants n (operation S309). The first calculation unit 15c then calculates the degree of risk based on the frequency of occurrence Ra of carrying out voice-attached image signal conferences and the average number of participants n (operation S310).

After that, the first calculation unit 15c repeatedly performs the processing from operation S302 to operation S310 until all the site IDs included in the operation information 13b have been selected (operation S311: No). Finally, when all the site IDs included in the operation information 13b have been selected (operation S311: Yes), the processing is terminated.

An Aspect of Advantages

As described above, when the load distribution apparatus 10 according to the present embodiment receives a request of image signal transmission between the terminals of a site worker and a remote supporter, the load distribution apparatus 10 determines a remote support server 20 to which the request is assigned based on history of changing the transmission mode to a voice-attached image signal transmission at the site 3 in process of transmission processing by the remote support server 20. Accordingly, it is possible to reduce uneven assignment of a voice-attached image signal conference to a part of the plurality of remote support servers 20A to 20C. Accordingly, with the load distribution apparatus 10 according to the present embodiment, it becomes possible to reduce deterioration in the quality of remote support.

### Second Embodiment

A description has been given of the disclosed apparatus according to the embodiment. However, it is possible to carry out the present disclosure in various different modes in addition to the embodiment described above. Thus, in the following, a description will be given of another embodiment included in the present disclosure.

Application of Calculation of Degree of Risk

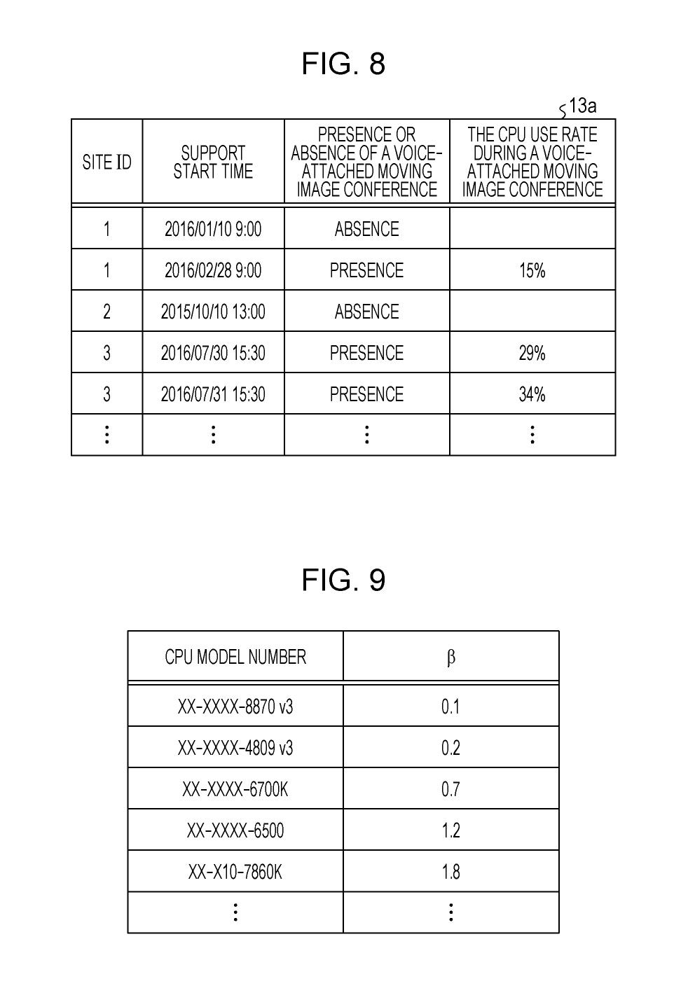

In the first embodiment, the case where the degree of risk is calculated based on the frequency of occurrence of holding voice-attached image signal conferences and the average number of participants is exemplified. However, it is also possible to calculate the degree of risk using the other items. For example, it is also possible for the load distribution apparatus 10 to calculate the degree of risk based on the frequency of occurrence of holding voice-attached image signal conferences and the average of the CPU use rate when a voice-attached image signal conference is held. In this case, during a time period from when the transmission mode is changed from image signal transmission to a voice-attached image signal conference until when the voice-attached image signal conference is terminated, the CPU use rate is collected from the remote support server 20 at fixed intervals, for example, at the intervals of one minute or five minutes, and the collected CPU use rates are averaged. In this case, the history information 13a becomes as illustrated in FIG. 8, for example.

FIG. 8 is a diagram illustrating an application of the history information 13a. The history information 13a illustrated in FIG. 8 differs from the history information 13a illustrated in FIG. 4 in the point that the average CPU use rate at the time of holding voice-attached image signal conferences is used in place of the number of participants. In this manner, by storing the average CPU use rate at the time of holding voice-attached image signal conferences, it is possible to calculate the degree of risk in accordance with the expression (3), for example. By calculating such a degree of risk, it is possible to reduce deterioration in the precision of the load prediction value due to disturbance of the other processes operating in the remote support server 20, and the like.

The degree of risk=the frequency of occurrence of holding voice-attached image signal conferences*the average CPU use rate at the time of holding voice-attached image signal conferences . . . expression (3)

Application of Calculation of Load Prediction Value

In the first embodiment, the case where the weighting factor β is fixed among the individual remote support servers 20 has been exemplified. However, it is possible to set the weighting factor β such that the higher the performance of the remote support server 20, the smaller the weighting factor β, and the lower the performance of the remote support server 20, the larger the weighting factor β. FIG. 9 is a diagram illustrating an example of setting information of the weighting factor β. As illustrated in FIG. 9, it is possible to store the setting information in which a value of the weighting factor β is associated with each model number of the CPU in the storage 13, and as an example, to calculate the load prediction value by inserting processing for reading a weighting factor β corresponding to the model number of the CPU mounted on the support server 20 after operation S103. Thereby, it is possible to calculate the load prediction value in consideration of the difference in the performance of each remote support server 20.

In this manner, when the performance of each remote support server 20 is taken into consideration, it is possible for the load distribution apparatus 10 not to assign a request to the remote support server 20 having the lowest load prediction value, but to calculate the load prediction value for each remote support server 20 on the assumption of assigning the request to each remote support server 20, and then to assign the request to a remote support server 20 having the lowest load prediction value. In this case, the degree of risk of the site ID having the received request of image signal transmission is calculated in addition to the site IDs included in the operation information 13b, and the load prediction value ought to be calculated by adding the degree of risk of the site ID having the received request of image signal transmission to the sum of the degree of risk when calculating the load prediction value of each remote support server 20, which is calculated in operation S104. Thereby, it is possible to improve the precision of the load prediction value.

Distribution and Integration

Also, each component of each unit illustrated in FIG. 3 does not have to be physically configured as illustrated in FIG. 3. That is to say, a specific form of distribution and integration of each unit is not limited to that illustrated in FIG. 3. It is possible to configure all of or a part of the unit by functionally or physically distributing of integrating them in any units in accordance with various loads, a use state, or the like. For example, the reception unit 15b, the history generation unit 15a, the first calculation unit 15c, the second calculation unit 15d, or the assignment unit 15e may be connected via a network as an external device of the load distribution apparatus 10. Also, the reception unit 15b, the history generation unit 15a, the first calculation unit 15c, the second calculation unit 15d, or the assignment unit 15e may be possessed by the other devices, respectively, and may cooperate with each other via a network so that the functions of the above-described load distribution apparatus 10 are realized. Also, all of or a part of the history information 13a, or the operation information 13b, which is stored in the storage 13, may be possessed by the other devices, respectively, and may cooperate with each other via a network so that the functions of the above-described load distribution apparatus 10 are realized.

Load Distribution Program

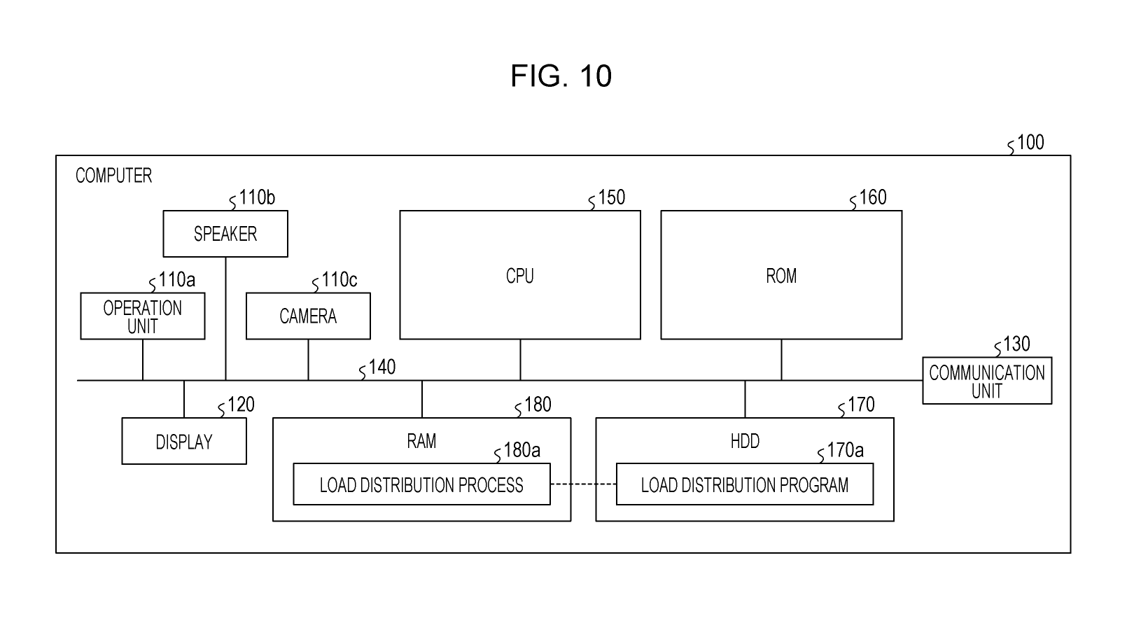

Also, it is possible to realize the various kinds of processing described in the embodiments by a computer, such as a personal computer, a workstation, or the like executing a program prepared in advance. Thus, in the following, a description will be given of an example of a computer that executes the same functions as those in the embodiments with reference to FIG. 10.

FIG. 10 is a diagram illustrating an example of the hardware configuration of a computer that executes load distribution programs according to the first embodiment and the second embodiment. As illustrated in FIG. 10, the computer 100 includes an operation unit 110a, a speaker 110b, a camera 110c, a display 120, and a communication unit 130. Further, the computer 100 includes a CPU 150, a ROM 160, an HDD 170, and a RAM 180. Each of these units 110 to 180 is connected via a bus 140.

As illustrated in FIG. 10, the HDD 170 stores a load distribution program 170a that performs the same functions as those of the reception unit 15b, the history generation unit 15a, the first calculation unit 15c, the second calculation unit 15d, and the assignment unit 15e, which are illustrated in the first embodiment. The load distribution program 170a may be integrated or distributed in the same manner as each component of the reception unit 15b, the history generation unit 15a, the first calculation unit 15c, the second calculation unit 15d, and the assignment unit 15e, which are illustrated in FIG. 3. That is to say, the HDD 170 does not have to store all the data illustrated in the first embodiment, and the data to be used for the processing ought to be stored in the HDD 170.

Under such circumstances, the CPU 150 loads the load distribution program 170a read from the HDD 170 into the RAM 180. As a result, the load distribution program 170a functions as a load distribution process 180a as illustrated in FIG. 10. The load distribution process 180a loads various kinds of data read from the HDD 170 into an area assigned to the load distribution process 180a out of the storage area of the RAM 180, and performs various kinds of processing using the loaded various kinds of data. For example, the processing illustrated in FIG. 6 and FIG. 7, or the like is included in as an example of the processing performed by the load distribution process 180a. In this regard, the CPU 150 does not have to perform all the processing illustrated in the first embodiment, the processing to be executed ought to be virtually performed.

In this regard, the load distribution program 170a does not have to be stored in the HDD 170 or the ROM 160 from the beginning. For example, a “portable physical medium” that is inserted into the computer 100, such as a flexible disk, namely an FD, a CD-ROM, a DVD disc, a magneto-optical disk, an IC card, or the like stores the load distribution program 170a. The computer 100 may then obtain the load distribution program 170a from the portable physical medium and may execute the program. Also, the load distribution program 170a may be stored in the other computer or a server device, or the like, which is connected to the computer 100 via a public line, the Internet, a LAN, a WAN, or the like, and the computer 100 may obtain the load distribution program 170a from the devices and execute the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A load distribution apparatus configured to control a plurality of transmission devices to distribute loads of signals to be transmitted by the plurality of transmission devices, the load distribution device comprising:
a memory; and
a processor coupled to the memory and the processor configured to:
receive a transmission request for transmitting an image signal without including a voice or a voice-attached image signal captured at a predetermined place;
calculate a probability of changing a transmission mode in a transmission device of the plurality of transmission devices from transmission of the image signal to transmission of the voice-attached image signal, based on a history of transmissions of the image signal and the voice-attached image signal at the predetermined place; and
assign the transmission request to the transmission device having the lowest probability among the plurality of transmission devices.

2. The load distribution apparatus according to claim 1,
wherein the processor is configured to calculate the probability, based on a frequency of occurrence of transmission of the voice-attached image signal at the predetermined place.

3. The load distribution apparatus according to claim 2,
wherein the processor is configured to calculate the probability based on a frequency of occurrence of the transmission of the voice-attached image signal at the predetermined place and a number of channels of a voice signal transmitted by the transmission device.

4. The load distribution apparatus according to claim 1,
wherein the processor is further configured to calculate a load prediction value, based on a load of the transmission device obtained from the transmission device and the probability, for each of the plurality of transmission devices, and
wherein the processor is configured to assign the transmission request to the transmission device having the minimum load prediction value.

5. The load distribution apparatus according to claim 1,
wherein the transmission of the image signal is one-way transmission from a first device coupled to the transmission device to a second device coupled to the transmission device, and the transmission of the voice-attached image signal is two-way transmission between the first device and the second device, the voice-attached image signal including the image signal of the one-way transmission and voice signals of the two-way transmission, and
wherein the transmission request is transmitted from the second device.

6. A load distribution method of a load distribution apparatus configured to control a plurality of transmission devices to distribute loads of signals to be transmitted by the plurality of transmission devices, the load distribution method comprising:
receiving a transmission request for transmitting an image signal without including a voice or a voice-attached image signal captured at a predetermined place;
calculating a probability of changing a transmission mode in a transmission device of the plurality of transmission devices from transmission of the image signal to transmission of the voice-attached image signal, based on a history of transmissions of the image signal and the voice-attached image signal at the predetermined place; and
assigning the transmission request to the transmission device having the lowest probability among the plurality of transmission devices, by a processor.
